(19) United States
(12) Patent Application Publication
(10) Pub. No.: US 2015/0278861 A1
(43) Pub. Date: Oct. 1, 2015

(54) INTENT AND TASK DRIVEN ADVERTISING MANAGEMENT IN SEARCH

(71) Applicant: MICROSOFT CORPORATION, Redmond, WA (US)

(72) Inventors: NEAL TIMOTHY OSOTIO, Sammamish, WA (US); EVA MARINA ILLESCAS SANCHEZ, Seattle, WA (US); DAVID C. SABEL, Saratoga, CA (US); SONIA NIJHAWAN, Mountain View, CA (US)

(73) Assignee: MICROSOFT CORPORATION, Redmond, WA (US)

(21) Appl. No.: 14/226,545

(22) Filed: Mar. 26, 2014

(51) Int. Cl. G06Q 30/02; G06F 17/30

(52) U.S. Cl. CPC G06Q 30/0256; G06F 17/30861

(57) ABSTRACT

Systems, methods, computer storage media, and user interfaces are provided for providing intent and task driven advertising. A search interaction is received from a user. The search interaction may include one or more intent signals. The search interaction may indicate the user is consuming content. A task driven module corresponding to the search interaction is provided. One or more additional intent signals are received from the user. An advertisement module is provided via the task driven module based on the search interaction and the additional intent signals. The advertisement module may be based on an advertisement campaign selected in response to the search interaction based on advertising obligations. A consumer decision journey state may be stored for the user allowing the continuation of the advertisement module without reentering a search associated with the search interaction, without reentering an application associated with the search interaction, and/or on a new device.

### BACKGROUND OF THE INVENTION

Search advertising experiences currently provide basic, single-action task interfaces and do not consider intent, location, time, device, or presentation surface. This results in an inefficient and poor user task driven experience. From an advertising perspective, this leads to minimal engagement with advertisements because the user is forced to leave the search workflow and navigate two or more separate sites. Once the user is engaged in the task, they are forced to complete the end-to-end workflow at that moment. For complex tasks or tasks that require larger amounts of time, the user has to abandon the task if the user needs to leave the session. Upon returning, the user must remember or re-do the task again from scratch. This decreases the overall user experience and increases the likelihood the intended end-to-end task will not be completed.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, computer storage media, and user interfaces are provided for providing intent and task driven advertising. A search interaction is received from a user. The search interaction may include one or more intent signals. The search interaction may indicate the user is consuming content. A task driven module corresponding to the search interaction is provided. One or more additional intent signals are received from the user. An advertisement module is provided via the task driven module based on the search interaction and the additional intent signals. The advertisement module may be based on an advertisement campaign selected in response to the search interaction based on advertising obligations. A consumer decision journey state may be stored for the user allowing the continuation of the advertisement module without reentering a search associated with the search interaction, without reentering an application associated with the search interaction, and/or on a new device.

### BRIEF DESCRIPTION OF THE DRAWING

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 schematically shows a network diagram suitable for performing embodiments of the present invention;

FIGS. 3-10 depict illustrative screen displays, in accordance with exemplary embodiments of the present invention;

FIG. 11 is a flow diagram showing an exemplary method for providing intent and task driven advertising, in accordance with an embodiment of the present invention; and

FIG. 12 is a flow diagram showing an exemplary method for selecting advertisements based on consumer decision journey states, in accordance with an embodiment of the present invention.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Advertisers often present advertisements to users in a search context. Users engaging in the search may be associated with an intent. Intent may refer to the target of the search or where the user is in the consumer decision journey (CDJ). As noted previously, intent is currently only utilized for providing search results. Advertisements associated with search (i.e., search ads) do not take advantage of intent, location, time, device, and/or presentation surface. The current search ads force users to jump out of the search workflow and visit the advertiser's site. This increases the cognitive load of the user and may result in workflow confusion as the user has to navigate two or more separate sites, rather than one. Current workflows also require the user to complete the end-to-end workflow at that time and moment. Complex workflows that may require a larger amount of time to complete are typically abandoned when the user leaves the session and the user has to remember or re-do the task again from scratch.

Various aspects of the technology described herein are generally directed to systems, methods, and computer-readable storage media for providing intent and task driven advertising management in search. Search ads are presented in a task driven module on the device surface. Content may be targeted based on the personal preferences of the user gathered via the personal data dashboard, search history, personal cloud data, and derived intent. The task driven module may be user initiated. Content and metadata may be provided across devices and mapped to the CDJ (e.g., open to possibility, decision to change, evaluating, shopping, experiencing, and the like) so the task driven module may provide a search ad that corresponds to the CDJ and the device receiving the user interaction. Task driven modules may change as the user engages with the search ad.

Accordingly, one embodiment of the present invention is directed to one or more computer storage media storing computer-useable instructions that, when used by one or more computing devices, cause the one or more computing devices to perform a method providing intent and task driven advertising. The method includes receiving a search interaction from a user, the search interaction including one or more intent signals. A task driven module corresponding to the search interaction is provided. One or more additional intent signals are received from the user. An advertisement module is provided via the task driven module based on the search interaction and the additional intent signals.

Another embodiment of the present invention is directed to one or more computer storage media storing computer-useable instructions that, when used by one or more computing devices, cause the one or more computing devices to perform a method selecting advertisements based on consumer decision journey states. The method includes receiving an indication a user is consuming content. An advertisement campaign is selected in response to the indication based on advertising obligations. A consumer decision journey state of the user is retrieved. An advertisement module is provided based on the advertisement campaign in accordance with the consumer decision journey state.

Yet another embodiment of the present invention includes a system for providing advertisements based on consumer decision journey states. The system includes one or more processors coupled to a computer storage medium, the computer storage medium having stored thereon a plurality of computer software components executable by the processor. The computer software components include a search component that receives a search interaction from a user. A campaign component determines advertising obligations that influence the selection of an advertisement based on the search query. A consumer decision journey state component determines a consumer decision journey state of the user. A storage component stores the consumer decision state of the user. A selection component selects an advertisement based on the advertising obligations and the consumer decision journey state of the user.

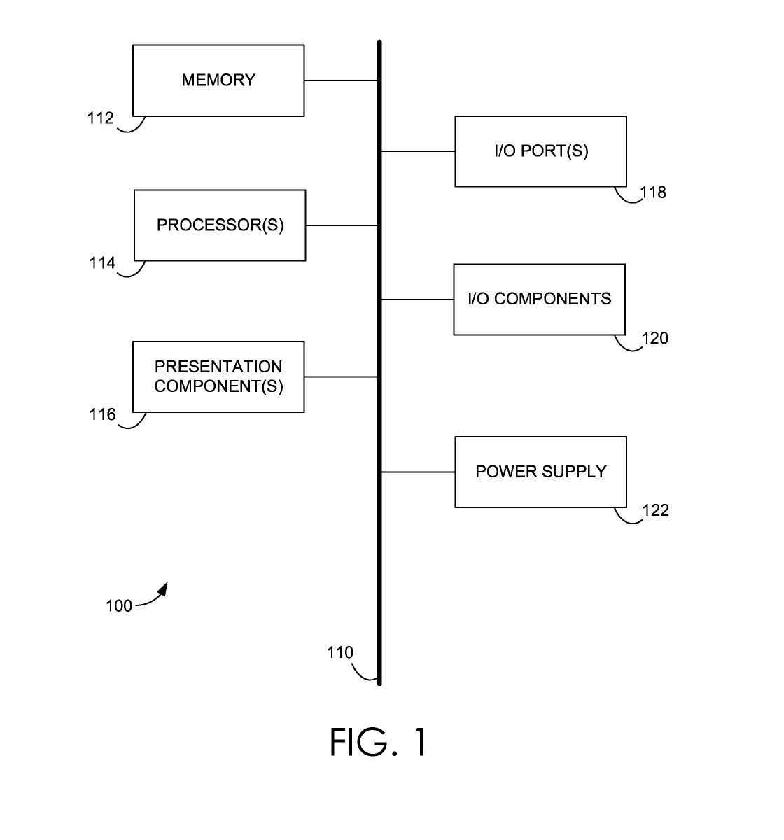

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures (i.e., motion or movements associated with a user's hand or hands or other parts of the user's body), voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like provided by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “advertising engine” is used herein, it will be recognized that this term may also encompass a server, a Web browser, a set of one or more processes distributed on one or more computers, one or more stand-alone storage devices, a set of one or more other computing or storage devices, any application, process, or device capable of providing search functionality or an advertisement module in response to a search interaction or an indication a user is consuming content.

As previously mentioned, embodiments of the present invention are generally directed to systems, methods, and computer-readable storage media for providing intent and task driven advertising. A search interaction is received from a user. The search interaction may include one or more intent signals. The search interaction may indicate the user is consuming content. A task driven module corresponding to the search interaction is provided. One or more additional intent signals are received from the user. An advertisement module is provided via the task driven module based on the search interaction and the additional intent signals. The advertisement module may be based on an advertisement campaign selected in response to the search interaction based on advertising obligations. A consumer decision journey state may be stored for the user. The consumer decision journey state may indicate the search interaction is a high level search with no expressed state, is associated with an expressed state, or is associated with an expressed state and has been refined by the user. The consumer decision journey state may allow the continuation of the advertisement module without reentering a search associated with the search interaction, without reentering an application associated with the search interaction, and/or on a new device.

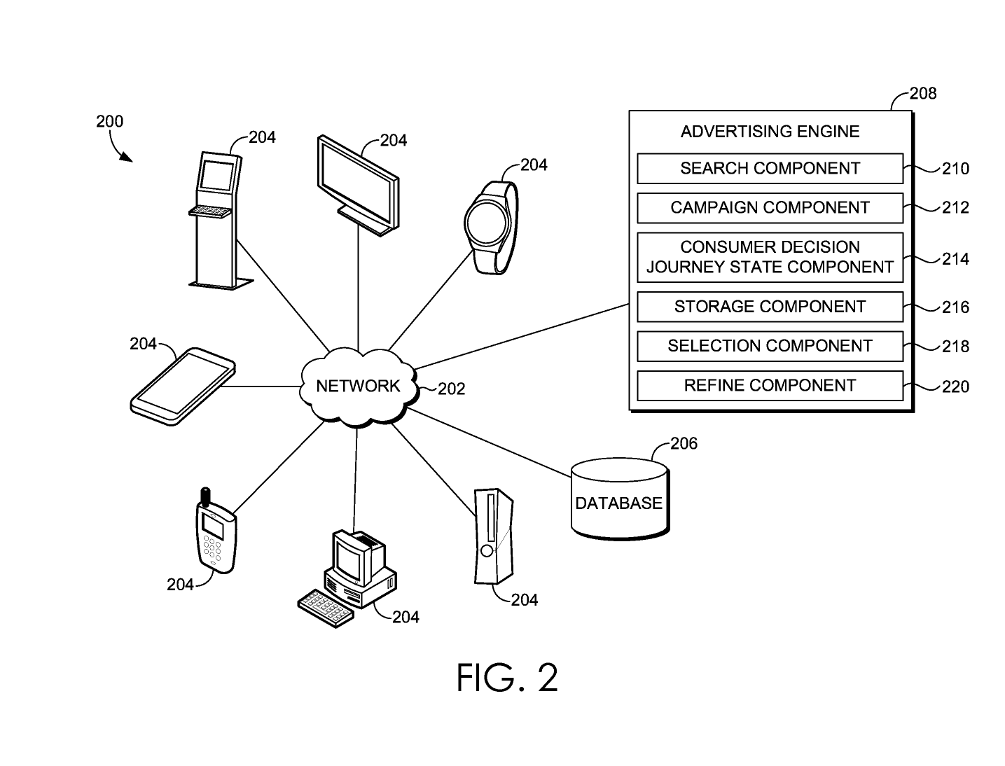

Referring now to FIG. 2, a block diagram is provided illustrating an exemplary computing system 200 in which embodiments of the present invention may be employed. Generally, the computing system 200 illustrates an environment in which intent and task driven advertising management is provided based on a consumer decision journey state that is captured from a search or interaction received from a remote device running a local front-end application that provides search functionality. The computing system 200 generally includes advertising engine 208, remote devices 204 (e.g., mobile device, television, kiosk, watch, touch screen or tablet device, workstation, gaming system, internet-connected consoles, and the like), and database 206, in communication with one another via a network 202. The network 202 may include, without limitation, one or more local area networks (LANs) and/or wide area networks (WANs). Such networking environments are commonplace in offices, enterprise-wide computer networks, intranets and the Internet. Accordingly, the network 202 is not further described herein.

It should be understood that any number of user computing devices 204, databases 206, and/or advertising engines 208 may be employed in the computing system 200 within the scope of embodiments of the present invention. Each may comprise a single device/interface or multiple devices/interfaces cooperating in a distributed environment. For instance, the advertising engine 208 may comprise multiple devices and/or modules arranged in a distributed environment that collectively provide the functionality of the advertising engine 208 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via a remote device 204, the advertising engine 208, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on and/or shared by any number of intent disambiguation engines and/or user computing devices. By way of example only, the advertising engine 208 might be provided as a single computing device (as shown), a cluster of computing devices, or a computing device remote from one or more of the remaining components. Additionally, the advertising engine 208 may be provided by a single entity or multiple entities. For instance, a search engine provider could provide a portion of the advertising engine 208 and/or database 206 and a separate provider could provide the remaining portion of the advertising engine 208 and/or database 206. Any and all such variations are contemplated to be within the scope of embodiments herein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The remote device 204 may include any type of computing device, such as the computing device 100 described with reference to FIG. 1, for example. Generally, the remote device 204 includes a display and is capable of executing a search or acting as a host for search results. Further, the remote device 204 is able to act as a host for receiving advertisements. The search process, among other things, is configured to render search engine home pages (or other online landing pages), search engine results pages (SERPs), and/or advertisements in association with the display of the remote device 204. The remote device 204 is further configured to receive user input of requests for various web pages (including search engine home pages), receive user input search queries, receive user input to identify and refine intent and/or interact with a task driven module (generally input via a user interface provided on the display and permitting alpha-numeric, voice, motion/gesture, and/or textual input into a designated input region) and to receive content for presentation on the display, for instance, from the advertising engine 208 and/or database 206. It should be noted that the functionality described herein as being performed by the remote device 204 and/advertising engine 208 may be performed by any operating system, application, process, web browser, web browser chrome or via accessibility to an operating system, application, process, web browser, web browser chrome, or any device otherwise capable of executing a search or acting as a host for search results and/or advertising. It should further be noted that embodiments of the present invention are equally applicable to mobile computing devices and devices accepting touch, gesture, and/or voice input. Any and all such variations, and any combination thereof, are contemplated to be within the scope of embodiments of the present invention.

The advertising engine 208 of FIG. 2 is configured to, among other things, provide intent and task driven advertising. As illustrated, in various embodiments, the advertising engine 208 includes a search component 210, a campaign component 212, a consumer decision journey state component 214, a storage component 216, a selection component 218, and a refine component 220. As illustrated, the advertising engine 208 may also have access to a database 206. The database 206 is a data store configured to store and associate intents with users or user identifications. The database 206 may further be configured to store and associate advertisements, sequences of advertisements, and advertisement campaigns with users or user identifications and devices associated with users. It will be understood and appreciated by those of ordinary skill in the art that the information stored in association with the database 206 may be configurable and may include any information relevant to search interactions, a search history associated with search interactions, users, advertisements, advertisement campaigns, intents, intent signals, metadata and devices associated with the users. The content and volume of such information are not intended to limit the scope of embodiments of the present invention in any way. Further, though illustrated as a single component, the database 206 may, in fact, be a plurality of storage devices, for instance a database cluster, portions of which may reside in association with the advertising engine 206, the remote devices 204, another external computing device (not shown), and/or any combination thereof. Further, the database 206 may be separated into multiple storage devices or database clusters (e.g., one database storing user information and a separate database storing advertisement information).

The search component 210 of the advertising engine 208 is configured to receive a search interaction from a user. The search interaction may be received from remote device 204. The search interaction may comprise one or more characters associated with a search query. The search interaction may include one or more intent signals. The search interaction may indicate the user is consuming content. A task driven module corresponding to the search interaction is provided. Upon receiving the one or more characters associated with the search interaction, the search component 210 communicates the search interaction to the campaign component 212.

In embodiments, the search component 210 receives additional information such as personal preferences. The additional information may be gathered via a personal data dashboard, a search history associated with the user, and personal cloud data. Initially, personal information may be provided based on content known by a search engine (e.g. BING). A remote device 204 associated with the user may provide additional details to the search component 210. For example, the remote device 204 may identify a geolocation associated with the user, indicate the user visited a particular location (e.g., a car dealership), or indicate the user diverted from a normal path to go to the particular location. Similarly, the remote device 204 may include communications to or from the user indicating the user may be in a particular consumer decision journey state for a particular item or type of item.

The campaign component 212 of the advertising engine 208 is configured to determine advertising obligations that influence the selection of an advertisement based on the search interaction. For instance, the provider of the search functionality may be contractually obligated to surface an advertisement for an advertisement a predetermined number of times or in a particular order upon receiving a particular search interaction. Based on the search interaction, the campaign component 212 determines if any advertising obligations apply that may require the selection of one advertisement over another. The campaign component 212 may further differentiate costs associated with an advertisement based on whether the user interacts with the consumer decision journey state component 214, described below. Similarly, the campaign component 212 may differentiate costs associated with an advertisement based on how much or how long the user interacts with the consumer decision journey state component 214.

The consumer decision journey state component 214 of the advertising engine 208 is configured to determine a consumer decision journey state of the user. The consumer decision journey state of the user may refer to the particular place in time for the decision making process of the user. This state may identify how likely the user is to engage with an advertisement containing high level detail, an advertisement with low level detail, or an advertisement anywhere between the two. The consumer decision journey state component 214 may present modular templates that receive information from the user associated with the consumer decision journey to ensure the advertiser provides the right advertisement in sequence at the right time to fully engage the user. The templates may be created by the advertiser or may be automatically built by the search provider based on intent signals received from or otherwise known about the user. The templates may engage the user to provide additional information that narrow down interests or timing or other preferences of the user. The interactions provide by the user may indicate that one particular advertisement is more likely to be appropriate for the user.

The storage component 216 of the advertising engine 208 is configured to store the consumer decision state of the user. The stored consumer decision state may be stored by storage component 216 in a database (e.g., database 206). Upon receiving a search interaction from the user, the search component 210 may communicate with the storage component 216 to retrieve, if available, the consumer decision journey state for the user. The stored consumer decision state enables the advertiser to provide the next advertisement in the sequence to the user even if the user is not using the device the user used to initiate or engage in the consumer decision journey for that particular advertisement. Similarly, the storage component 216 may store additional information associated with the user. The additional information may be communicated to the search component 210 to indicate how engaged the user may be with a particular advertisement or advertisement sequence. For example, although the user may have previously indicated a particular consumer decision journey state, the remote device 204 may receive signals (e.g., accelerometer patterns of the device, gaze detection, and the like) indicating the user is or is not engaged with the advertisement. These indications may be stored by the search component 210 and influence future or additional advertisements.

Selection component 218 of the advertising engine 208 is configured to select an advertisement based on the advertising obligations and the consumer decision journey state of the user. As noted previously, the selection component 218 may receive signals from the storage component 216 indicating the engagement of the user with a particular advertisement or sequence in the advertisement. The selection component 218 may determine that a previously viewed advertisement may need to be provided again, because the user was not sufficiently engaged with that advertisement or because the consumer decision journey state of the user has changed.

In one embodiment, the refine component 220 of the advertising engine 208 is configured to determine a refined consumer decision journey state of the user based on additional search interactions and/or intent signals. The select component 218 may select a refined advertisement based on the refined consumer decision journey. The refined consumer decision journey state may be based on intent signals received from the user. The refined consumer decision journey state may additionally be based on a detection or determination of the engagement of the user with a previously provided advertisement.

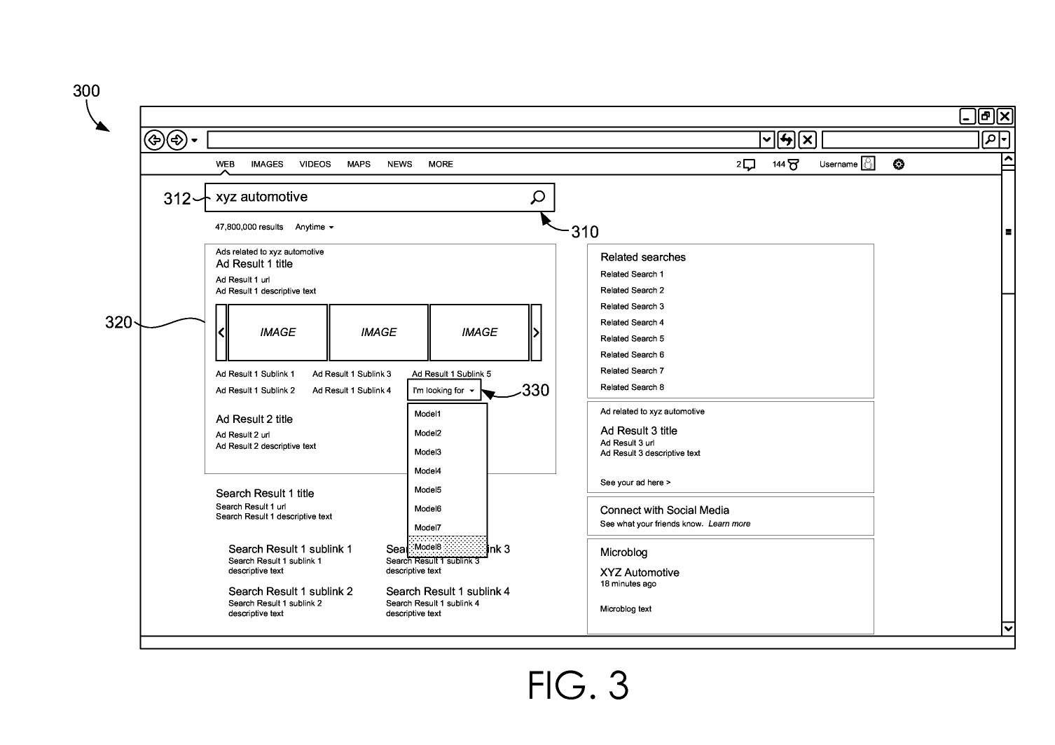

With reference to FIGS. 3-10, illustrative screen displays for intent and task driven advertising are provided. It is understood that each of the illustrative screen displays are connected logically, such that they comprise a user interface designed for providing intent and task driven advertising. The screen displays may appear in any order and with any number of screen displays, without regard to whether the screen display is described or depicted herein.

Referring now to FIG. 3, an illustrative screen display 300 of an embodiment of the present invention is shown. A search display area displays a search bar 310 for receiving a search interaction 312 from a user corresponding to a search interaction. Advertisement display area 320 displays a task driven module corresponding to the search interaction. Additional intent signals may be received from the user by interacting with the advertisement extension display area 330. This interaction allows the appropriate advertisement to be provided to the user.

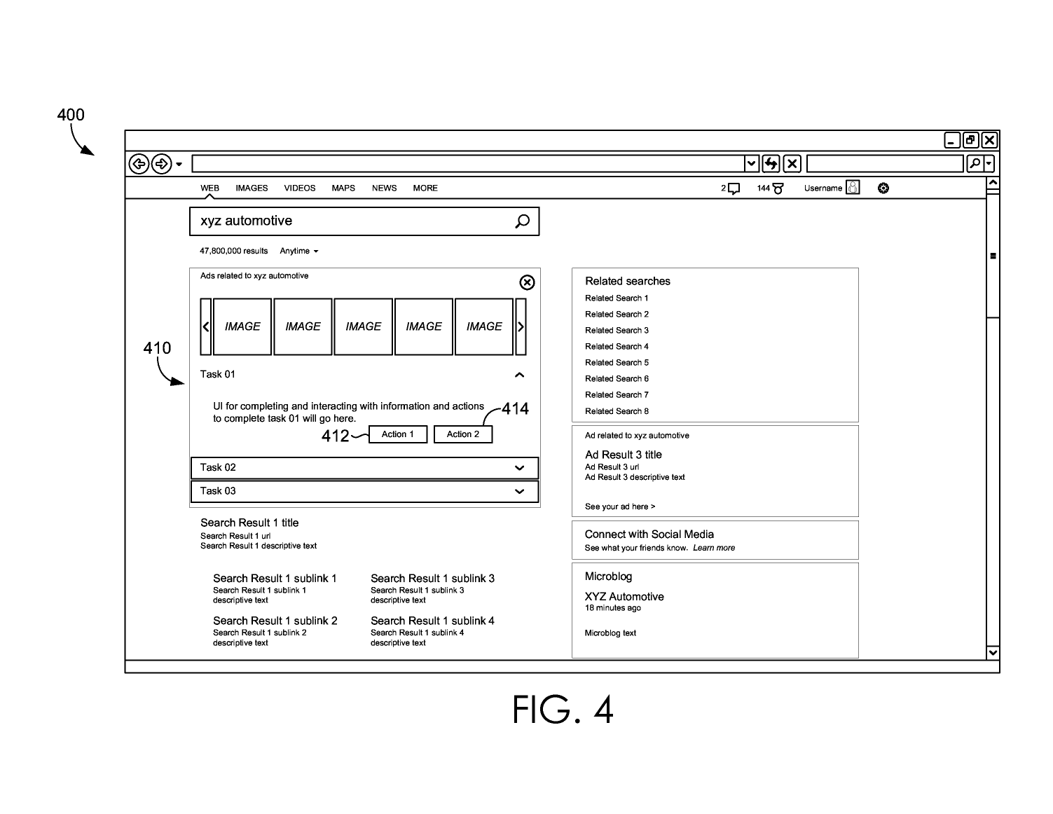

In FIG. 4, an illustrative screen display 400 of an embodiment of the present invention is shown. The search interaction received from the user may prompt a series of tasks 410, 412, 414 to be provided. Each task may incrementally determine additional information about the user to provide a more targeted advertisement. The additional information may be received via selectable actions 412, 414 that are selected upon the user interacting with the desired action. The action may identify the consumer decision journey state of the user and may identify a new workflow that provides an additional task.

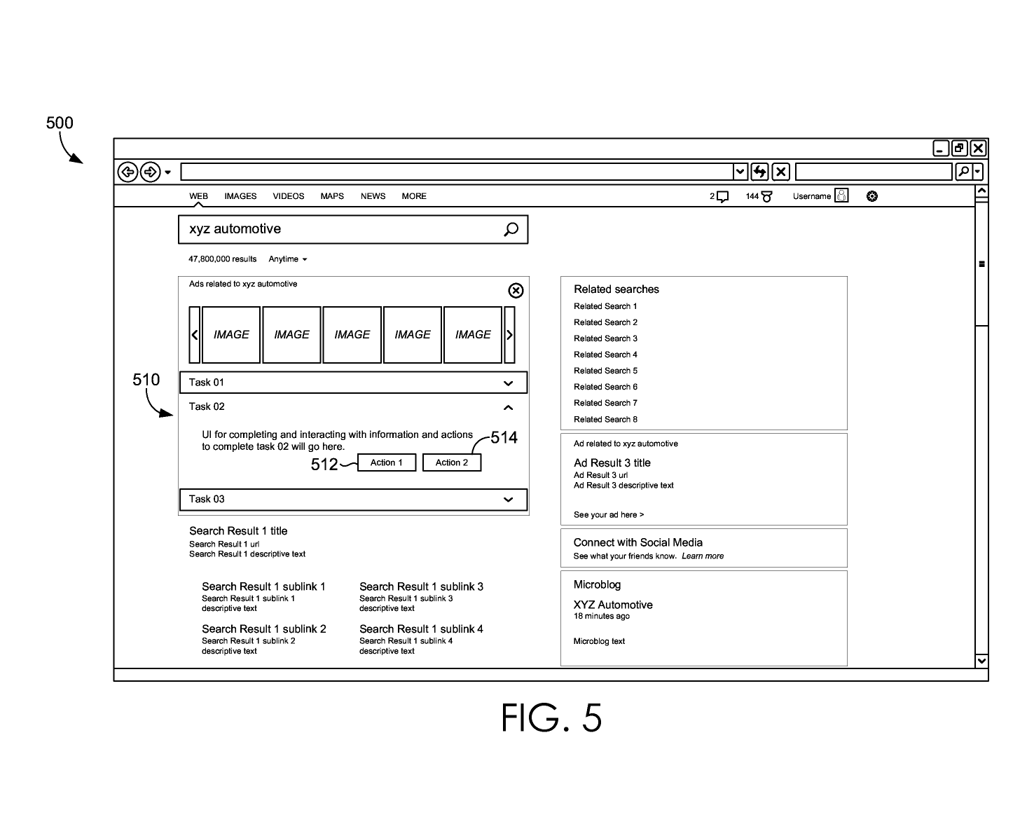

Turning now to FIG. 5, an illustrative screen display 500 of an embodiment of the present invention is shown. As illustrated, as the user interacts with each task, additional tasks 510 and selectable actions 512, 514 are provided. Each task and selectable action is related to the previous task and selectable action and represents the next step in the end-to-end task completion workflow.

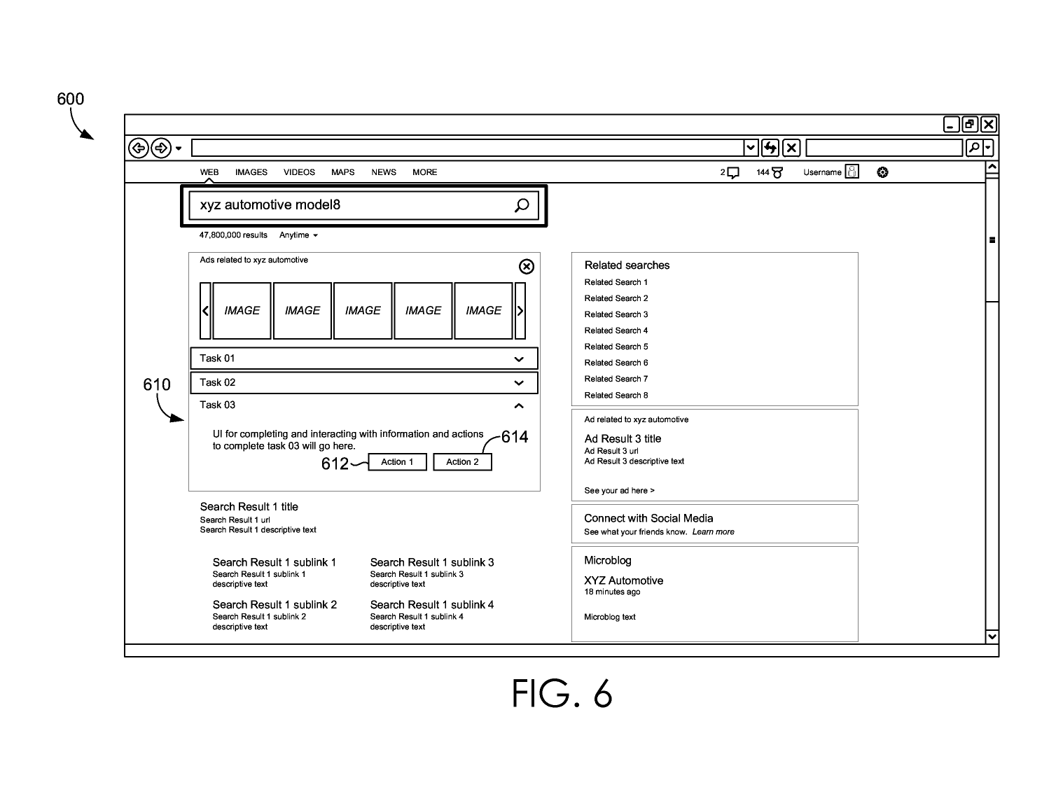

Referring now to FIG. 6, an illustrative screen display 600 of an embodiment of the present invention is shown. Even if the user closes out an initial session and returns with a different, but related query, the initial driven task module is provided based upon the search interaction is provided in a continued state. Any additional intent signals that have been received via the selectable actions for the various provided tasks are accounted for and the workflow continues where the user left off. As illustrated, the user is provided a follow-up task 610 selectable actions 612, 614. This allows the user to finish out the end-to-end task completion workflow without starting over. More simply, the task driven module follows the user through the consumer decision journey and is available to complete the subsequent tasks in the workflow even if the user takes a break or switches devices.

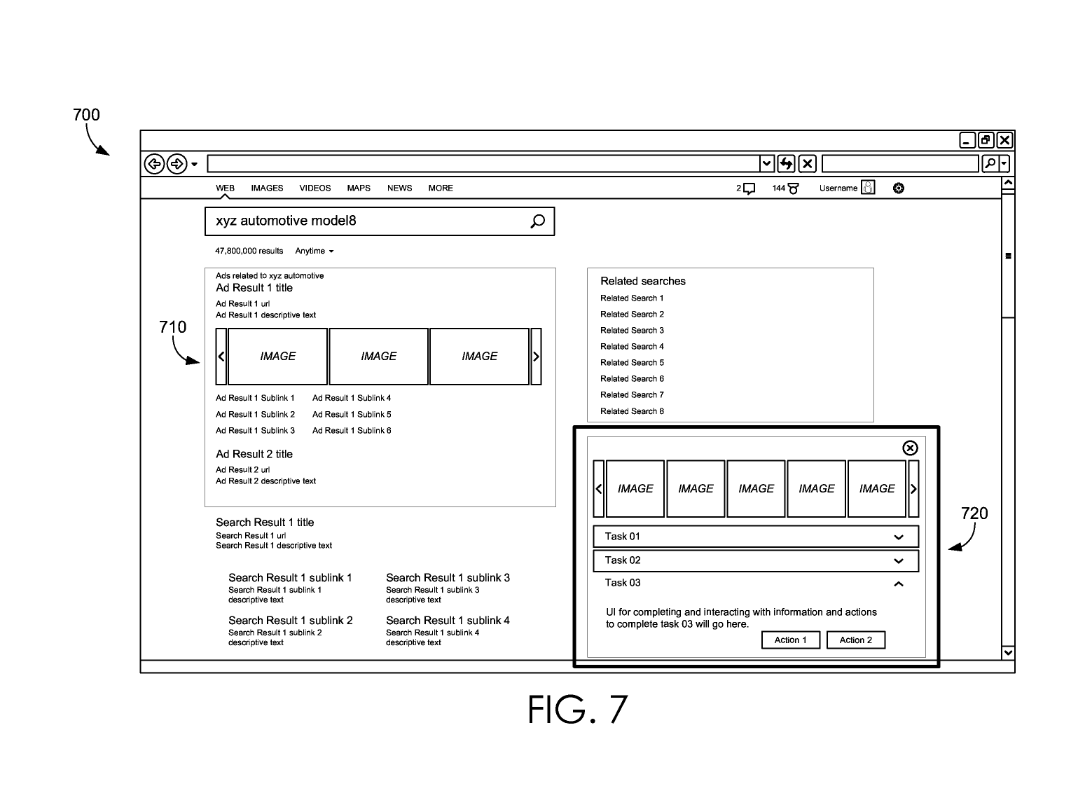

With reference now to FIG. 7, an illustrative screen display 700 of an embodiment of the present invention is shown. If the user has delayed completion of the initial task, the task driven module 720 may move from a more prominent position in the search results 710 to a less prominent position of the display (e.g., off to the side, smaller, etc.). If additional time passes without further interaction, the task driven module 720 may no longer be provided. As can be appreciated the amount of time that must pass before the task driven module 720 is moved to a less prominent position or reduced in size or removed completely may be configured. Further, an advertiser may be charged more or less based on this amount of time.

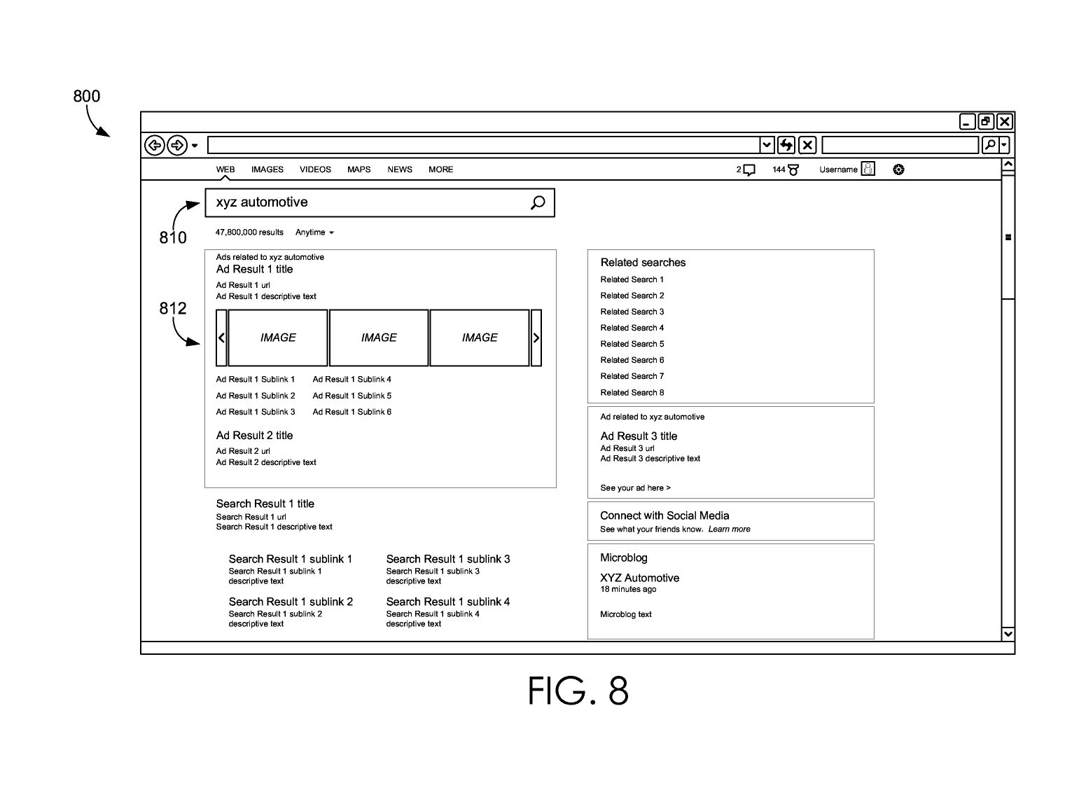

In FIG. 8, an illustrative screen display 800 of an embodiment of the present invention is shown. As illustrated, the configurable time has passed indicating the intent of the user has diminished resulting in the task driven module no longer being displayed. Accordingly, as the user provides the search interaction 810, the search results 812 may be provided without the task driven module.

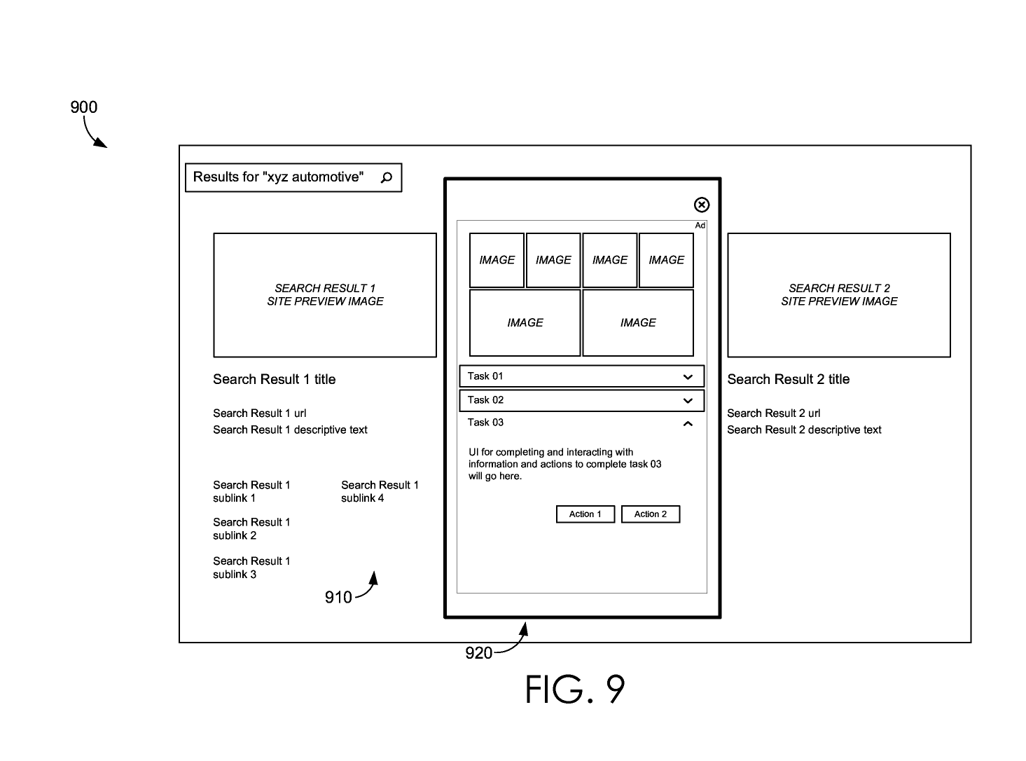

Referring now to FIG. 9, an illustrative screen display 900 of an embodiment of the present invention is shown. As illustrated, the device type and the application providing the search functionality may influence the display and layout of the task driven module. In this example, the search results 910 and task driven module 920 may be provided as charms.

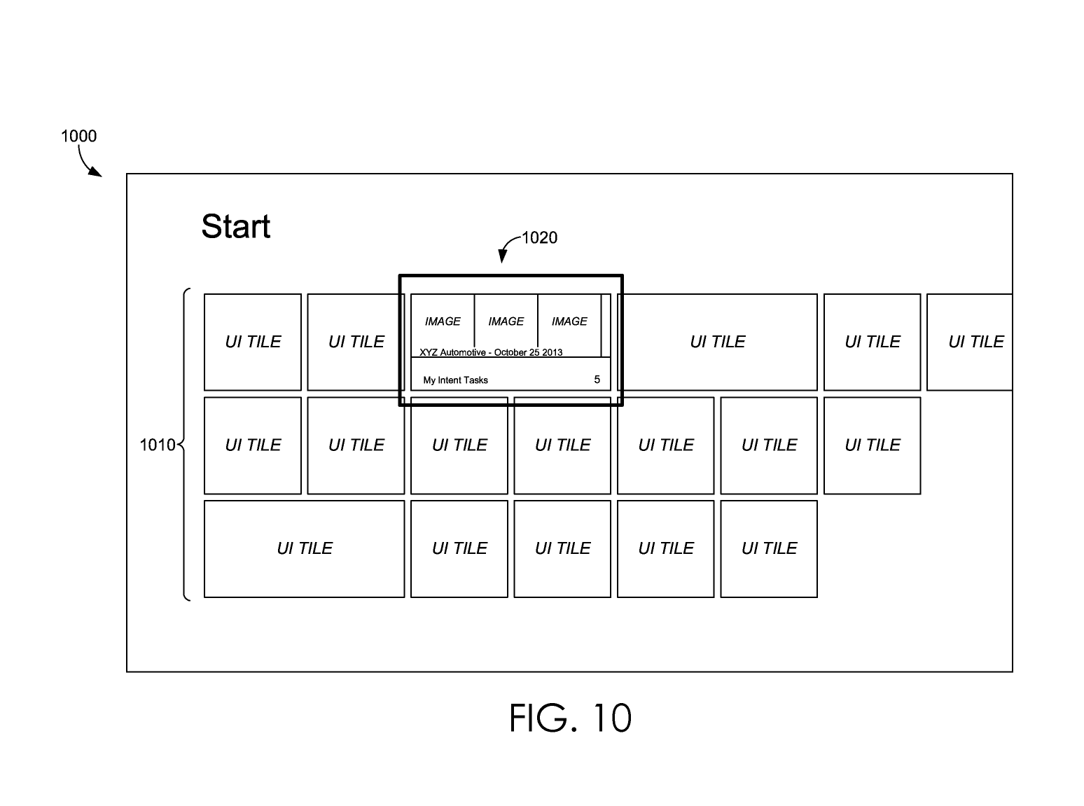

With reference now to FIG. 10, an illustrative screen display 1000 of an embodiment of the present invention is shown. As illustrated, the task driven module 1020 may be saved on a start page to be continued at a later time. This enables the user to access when the user is ready to continue the end-to-end workflow to complete the task drive search. In this example, the task driven module 1020 appears on the start page along with other tiles 1010 provided by the operating system or configured by the user to be provided on the start page.

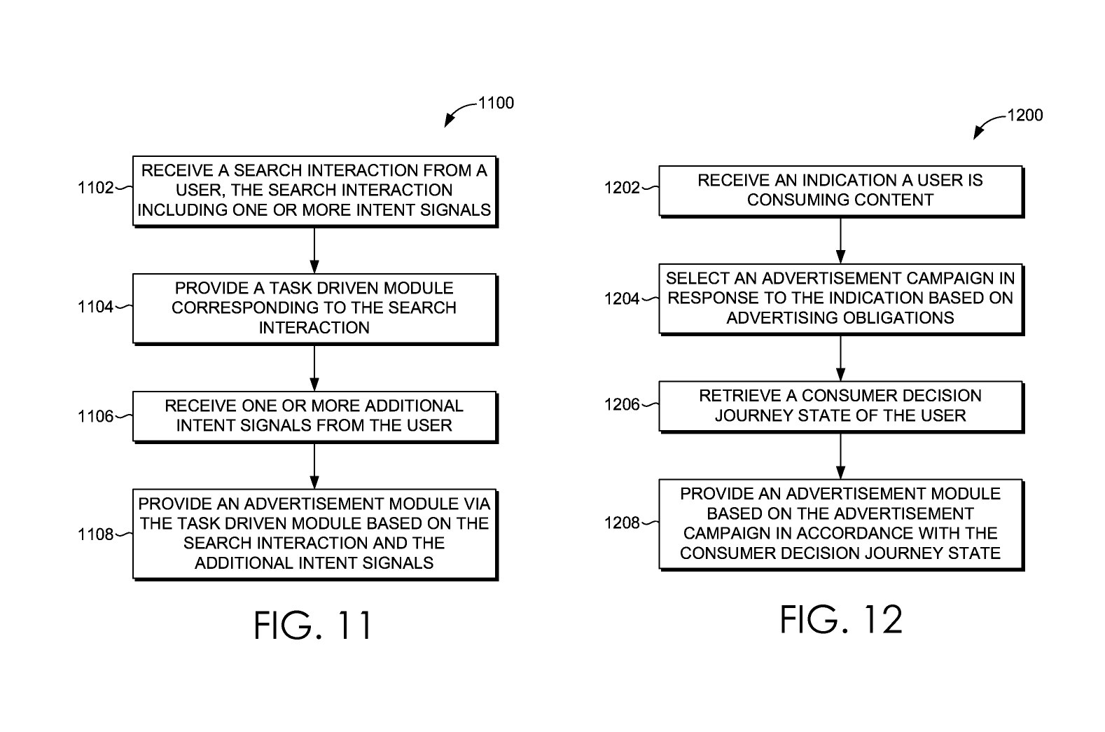

Referring now to FIG. 11, a flow diagram is provided that illustrates a method 1100 for providing intent and task driven advertising, in accordance with an embodiment of the present invention. As shown at block 1102, a search interaction is received from a user. The search interaction may include one or more intent signals. The search interaction may comprise an interaction with a device or application. The interaction may include a search prefix comprising one or more characters associated with a search query. The interaction may include a gesture or voice command. The interaction may include a navigation within an application or on a device such as a movement of a cursor, mouse, or a touch on a display.

As shown at block 1104, a task driven module corresponding to the search interaction is provided. The task driven module may be provided on any device associated with the user. The task driven module may adapt or change based on additional interactions or additional intent signals are received from the user, at step 1106. These additional intent signals may indicate a consumer decision journey state associated with the user.

In one embodiment, the consumer decision journey state of the user is stored. The stored consumer decision journey state may be retrieved for later use. In one embodiment, the advertisement module is continued on a new device based on the consumer decision journey state. In one embodiment, advertisement module is continued without reentering a search associated with the search interaction based on the consumer decision journey state. In one embodiment, the advertisement module is continued without reentering an application associated with the search interaction based on the consumer decision journey state.

In one embodiment, the consumer decision journey state indicates the search interaction is a high level search with no expressed state. In one embodiment, the consumer decision journey state indicates the search interaction is associated with an expressed state. In one embodiment, the consumer decision journey state indicates the search interaction is associated with an expressed state and has been refined by the user.

At step 1108, an advertisement module is provided via the task driven module based on the search interaction and the additional intent signals. The advertisement module is tailored to the consumer decision journey state of the user. In one embodiment, preferences of the user are received via a personal data dashboard, a search history, personal cloud data, and/or derived intent. The preferences may be utilized to determine intent signals and used to select content associated with an advertisement. The preference may additionally be utilized to determine additional intent signals or, more specifically, the consumer decision journey state of the user. In one embodiment, the task driven module provides the advertisement module based on the preferences.

Referring now to FIG. 12, a flow diagram is provided that illustrates a method 1200 for selecting advertisements based on consumer decision journey states, in accordance with an embodiment of the present invention. As shown at block 1202, an indication a user is consuming content is received. The indication may be associated with a search interaction. In one embodiment, the indication may be based on a personal data dashboard, a search history, personal cloud data, and/or derived intent. An advertisement campaign is selected, at block 1204, in response to the indication based on advertising obligations.

A consumer decision journey state of the user is retrieved at block 1206. The consumer decision journey state may indicate the search interaction is a high level search with no expressed state. The consumer decision journey state may indicate the search interaction is associated with an expressed state. The consumer decision journey state may indicate the search interaction is associated with an expressed state and has been refined by the user. In one embodiment, an updated consumer decision journey state of the user is stored. A sequence of the advertisement module may be updated based on the updated consumer decision journey state. In one embodiment, an indication the user is consuming content on a different device is received. The advertisement module may be provided on the different device based on the advertisement campaign in accordance with the consumer decision journey state.

As can be understood, embodiments of the present invention provide systems, methods, and computer-readable storage media for, among other things, providing intent and task driven advertising management in search. Search ads are presented in a task driven module on the device surface. Content may be targeted based on the personal preferences of the user gathered via the personal data dashboard, search history, personal cloud data, and derived intent. The task driven module may be user initiated. Content and metadata may be provided across devices and mapped to the CDJ (e.g., open to possibility, decision to change, evaluating, shopping, experiencing, and the like) so the task driven module may provide a search ad that corresponds to the CDJ and the device receiving the user interaction. Task driven modules may change as the user engages with the search ad.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in methods 1100 of FIGS. 11 and 1200 of FIG. 12 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. Computer storage media having computer-executable instructions embodied thereon that, when executed by one or more computing devices, cause the one or more computing devices to perform a method of providing intent and task driven advertising, the method comprising:
receiving a search interaction from a user, the search interaction including one or more intent signals;
providing a task driven module corresponding to the search interaction;
receiving one or more additional intent signals from the user; and
providing an advertisement module via the task driven module based on the search interaction and the additional intent signals.

2. The media of claim 1, further comprising receiving preferences via a personal data dashboard, search history, personal cloud data, and derived intent.

3. The media of claim 2, wherein the task driven module further provides the advertisement module based on the preferences.

4. The media of claim 1, further comprising storing a consumer decision journey state for the user.

5. The media of claim 4, wherein the consumer decision journey state indicates the search interaction is a high level search with no expressed state.

6. The media of claim 4, wherein the consumer decision journey state indicates the search interaction is associated with an expressed state.

7. The media of claim 4, wherein the consumer decision journey state indicates the search interaction is associated with an expressed state and has been refined by the user.

8. The media of claim 4, further comprising continuing the advertisement module without reentering a search associated with the search interaction based on the consumer decision journey state.

9. The media of claim 4, further comprising continuing the advertisement module without reentering an application associated with the search interaction based on the consumer decision journey state.

10. The media of claim 4, further comprising continuing the advertisement module on a new device based on the consumer decision journey state.

11. Computer storage media having computer-executable instructions embodied thereon that, when executed by one or more computing devices, cause the one or more computing devices to perform a method of providing intent and task driven advertising, the method comprising:
receiving an indication a user is consuming content;
selecting an advertisement campaign in response to the indication based on advertising obligations;
retrieving a consumer decision journey state of the user; and
providing an advertisement module based on the advertisement campaign in accordance with the consumer decision journey state.

12. The media of claim 11, wherein the consumer decision journey state indicates the search interaction is a high level search with no expressed state.

13. The media of claim 11, wherein the consumer decision journey state indicates the search interaction is associated with an expressed state.

14. The media of claim 11, wherein the consumer decision journey state indicates the search interaction is associated with an expressed state and has been refined by the user.

15. The media of claim 11, further comprising storing an updated consumer decision journey state.

16. The media of claim 15, further comprising updating a sequence of the advertisement module based on the updated consumer decision journey state.

17. The media of claim 11, further comprising receiving an indication the user is consuming content on a different device.

18. The media of claim of claim 17, further comprising providing the advertisement module on the different device based on the advertisement campaign in accordance with the consumer decision journey state.

19. A system for providing advertisements based on consumer decision journey states comprising:
one or more processors coupled to a computer storage medium, the computer storage medium having stored thereon a plurality of computer software components executable by the processor, the computer software components comprising:
a search component that receives a search interaction from a user;
a campaign component that determines advertising obligations that influence the selection of an advertisement based on the search query; and
a consumer decision journey state component that determines a consumer decision journey state of the user;
a storage component that stores the consumer decision state of the user; and
a selection component that selects an advertisement based on the advertising obligations and the consumer decision journey state of the user.

20. The system of claim 19 further comprising a refine component that determines a refined consumer decision journey state of the user based on additional search interactions and/or intent signals, wherein the selection component selects a refined advertisement based on the refined consumer decision journey.
